(19) United States
(12) Patent Application Publication
(10) Pub. No.: US 2026/0319583 A1
(43) Pub. Date: Oct. 15, 2026

(54) VIRTUAL REALITY GLOVE AND VIRTUAL REALITY PRODUCT

(71) Applicant: GOERTEK INC., Weifang (CN)

(72) Inventors: Tao WANG, Weifang (CN); Xin MENG, Weifang (CN)

(21) Appl. No.: 19/690,385

(22) Filed: May 28, 2026

Related U.S. Application Data
(63) Continuation of application No. PCT/CN2024/135140, filed on Nov. 28, 2024.

(30) Foreign Application Priority Data
Dec. 15, 2023 (CN) 202311734819.6

(51) Int. Cl. G06F 3/01; A41D 19/00

(52) U.S. Cl. CPC G06F 3/014; A41D 19/0024

(57) ABSTRACT

A virtual reality glove includes a glove body, a heater, a controller, a communicator and a mode switch. The heater is provided at the glove body and configured to heat a container to be heated held by the glove body. The controller is provided at the glove body and electrically connected to the heater. The communicator is provided at the glove body and electrically connected to the controller. The mode switch is provided at the glove body and electrically connected to the controller. The virtual reality glove is configured to switch between a real-world application mode and a virtual application mode through the mode switch.

### CROSS-REFERENCE TO RELATED APPLICATIONS

The present application is a continuation application of International Application No. PCT/CN2024/135140, filed on Nov. 28, 2024, which claims priority to Chinese Patent Application No. 202311734819.6, filed on Dec. 15, 2023. The disclosures of the above-mentioned applications are incorporated herein by reference in their entireties.

### TECHNICAL FIELD

The present application relates to the technical field of virtual reality, and in particular to a virtual reality glove and a virtual reality product.

### BACKGROUND

Virtual reality is a high-end technology emerging in recent years. Virtual reality uses a computer to simulate and generate a three-dimensional virtual world, providing users with simulations of visual, auditory, tactile and other senses, allowing users to feel immersed and observe things in the three-dimensional space in a timely and unrestricted manner.

However, in the related art, there is no intelligent device that can integrate real-world and metaverse applications. For example, a real-life product can act on real objects but is difficult to access the metaverse to exert a corresponding effect in the metaverse; alternatively, such an intelligent device can only act on virtual objects in the metaverse and cannot exert a corresponding effect in real life. This makes it difficult for users to experience a stronger sense of realism that is indistinguishable from the real world.

### SUMMARY

The main objective of the present application is to provide a virtual reality glove, aiming to provide an intelligent device that integrates real-world and metaverse applications.

To achieve the above objective, the virtual reality glove provided by the present application includes: a glove body, a heater provided at the glove body and configured to heat a container to be heated held by the glove body, a controller provided at the glove body and electrically connected to the heater, and a communicator provided at the glove body and electrically connected to the controller.

The virtual reality glove is configured to switch between a real-world application mode and a virtual application mode through the mode switch;
in the real-world application mode, the controller is configured for controlling the heater to operate; and
in the virtual application mode, the controller is in communication with a virtual reality device through the communicator to send a trigger instruction for capturing a motion of the glove body to the virtual reality device.

In an embodiment, the glove body includes a main body portion and a plurality of finger portions provided at the main body portion, and the controller and the communicator are provided at the main body portion; and
the heater includes a plurality of heating members provided on at least one of the main body portion and the plurality of finger portions, and the plurality of heating members are correspondingly provided at sides of the plurality of finger portions facing the container to be heated when the heater is provided at the plurality of finger portions.

In an embodiment, the plurality of heating members extend along extension directions of the plurality of finger portions, and a thermal insulation member is provided at one sides of the plurality of heating members facing away from the container to be heated.

In an embodiment, a container detector is provided at the glove body and electrically connected to the controller, the container detector is configured to sense that the container to be heated is held by the glove body and transmit to the controller to drive the heater to operate.

In an embodiment, the container detector is configured as a pressure sensor, the pressure sensor is configured to sense a pressing force applied by the glove body to the container to be heated and transmit to the controller to drive the heater to operate.

In an embodiment, a plurality of pressure sensors are provided, the controller is configured to acquire a plurality of pressure values from the plurality of pressure sensors, calculate an average pressure value based on the plurality of pressure values, and drive the heater to operate according to the average pressure value.

In an embodiment, a first pressure range and a second pressure range are preset in the controller, and the first pressure range is lower than the second pressure range;
when it is determined that the average pressure value falls within the first pressure range, the controller does not drive the heater to operate; and
when it is determined that the average pressure value falls within the second pressure range, the controller is configured to drive the heater to operate.

In an embodiment, at least one of the heater and the container detector is electrically connected to the controller through a flexible printed circuit, and the flexible printed circuit is configured to extend from at least one of the heater and the container detector to the controller.

In an embodiment, a mounting cavity for mounting the controller is formed in the glove body, and the mounting cavity is provided with an opening facing outward; and
a mounting cover plate is configured to cover the opening, a control switch is fixed on the mounting cover plate, and the control switch is electrically connected to the controller.

In an embodiment, the virtual reality glove is further provided with a temperature feedback apparatus communicatively connected to the controller and the virtual reality device respectively, where in the virtual application mode, the controller is in communication with the temperature feedback apparatus to control the temperature feedback apparatus to operate.

The present application further provides a virtual reality product, which includes a virtual reality device and the virtual reality glove as described above. The controller of the virtual reality glove is communicatively connected to the virtual reality device through the communicator.

In an embodiment, the virtual reality device includes a 3D construction module and a real-world capture module communicatively connected to the 3D construction module, the 3D construction module is configured to construct a virtual space, and the virtual space includes a virtual glove corresponding to a glove body and a virtual container to be heated corresponding to a container to be heated; and
in a virtual application mode, the controller is communicatively connected to the 3D construction module and the real-world capture module through the communicator respectively, the real-world capture module is configured to capture a motion of the glove body and map to the virtual glove, so that the virtual glove is configured to hold the virtual container to be heated and heat the virtual container to be heated.

In an embodiment, the real-world capture module includes a camera module, a sensor module and a mapping module communicatively connected to the 3D construction module, the camera module and the sensor module are configured to monitor the motion of the glove body and transmit to the mapping module, and the mapping module is configured to map to the virtual glove.

In an embodiment, in the virtual application mode, the virtual glove is configured to heat the virtual container to be heated to a target temperature; and
the controller is configured to acquire the target temperature, and control a temperature feedback apparatus to operate to feed back the target temperature to a user when detecting that the temperature feedback apparatus on the virtual reality glove contacts the virtual container to be heated.

In an embodiment, in the virtual application mode, the virtual glove is configured to heat the virtual container to be heated to a target temperature; and
the 3D construction module is configured to construct a virtual temperature detection apparatus, the virtual temperature detection apparatus is configured to detect a temperature of the virtual container to be heated, and the virtual reality device is configured to acquire the target temperature and display the target temperature in the virtual space.

In an embodiment, a mode switch is switched to the virtual application mode, the virtual reality device is configured to pop up a selection window in the virtual space for a user to select whether the controller is in communication with the virtual reality device.

In an embodiment, the virtual reality product further includes a container to be heated, where the container to be heated is configured as a cup to be heated, the cup to be heated includes a heat conduction section and two thermal insulation sections provided at two ends of the heat conduction section, and the heater is configured to heat conduction section to heat a liquid to be heated in the cup to be heated.

The technical solution of the present application provides a glove body, and the glove body is provided with a heater, a controller, a communicator and a mode switch. The heater is configured to heat a container to be heated held by the glove body. The controller, the communicator and the mode switch are all electrically connected to the heater. In the real-world application mode, a user can wear the virtual reality glove and hold the container to be heated, and then the controller controls the heater to operate, so that the container to be heated is heated by the heater to a preset temperature, thereby realizing the function of the virtual reality glove to heat the container to be heated in real life. The mode switch enables the virtual reality glove to switch between the real-world application mode and the virtual application mode. After the user wears the virtual reality device, turning on the mode switch allows access to the metaverse. The controller then is in communication with the virtual reality device through the communicator to connect the virtual reality glove to the metaverse and send a trigger instruction for capturing the motion of the glove body to the virtual reality device. This allows the virtual reality device to capture the motion of the glove body and map it to the metaverse, thereby realizing the heating function of the virtual glove in the metaverse, which corresponds to the function of the virtual reality glove in real life. The virtual reality glove thus integrates real-world and metaverse applications, providing an intelligent device that allows a user to perform a preset action in real life and a corresponding virtual action in the metaverse by wearing the same device with the assistance of the virtual reality device. This further enhances the interactivity between the metaverse and the real world, enabling the user to experience a stronger sense of realism in the metaverse that is indistinguishable from the real world.

### BRIEF DESCRIPTION OF THE DRAWINGS

In order to illustrate the technical solutions in the embodiments of the present application or in the related art more clearly, the following briefly introduces the accompanying drawings required for the description of the embodiments or the related art. Obviously, the drawings in the following description are only part of embodiments of the present application. For those skilled in the art, other drawings can also be obtained according to the structures shown in these drawings without any creative effort.

FIG. 1 is a structural schematic view of a virtual reality glove from one angle according to an embodiment of the present application.

FIG. 2 is a structural schematic view of the virtual reality glove of FIG. 1 from another angle.

FIG. 3 is a structural schematic view of the virtual reality glove of FIG. 1 heating a container to be heated.

FIG. 4 is an exploded view of the virtual reality glove of FIG. 1.

FIG. 5 is an internal structural schematic view of the virtual reality glove of FIG. 1.

FIG. 6 is a cross-sectional view of the virtual reality glove heating the container to be heated of FIG. 3.

FIG. 7 is a partial enlarged view of a finger portion of FIG. 6.

FIG. 8 is a structural schematic view of the container to be heated of FIG. 1.

The realization of the objective, functional characteristics, and advantages of the present application are further described with reference to the accompanying drawings.

### DETAILED DESCRIPTION OF THE EMBODIMENTS

The technical solutions of the embodiments of the present application will be described in more detail below with reference to the accompanying drawings. It is obvious that the embodiments to be described are only some rather than all of the embodiments of the present application. All other embodiments obtained by those skilled in the art based on the embodiments of the present application without creative efforts shall fall within the scope of the present application.

It should be noted that, if directional indications (such as up, down, left, right, front, back, etc.) are involved in the embodiments of the present application, the directional indications are only used to explain the relative positional relationship and movement between components under a specific posture (as shown in the drawings). If the specific posture changes, the directional indications change accordingly.

In addition, if the description of “first”, “second” and the like is involved in the embodiments of the present application, the description of “first”, “second” and the like is only for descriptive purposes and cannot be understood as indicating or implying their relative importance or implicitly indicating the number of indicated technical features. Thus, a feature defined with “first” and “second” may explicitly or implicitly include at least one such feature. In addition, the expression “and/or” as used throughout means including three parallel schemes, for example, “A and/or B” includes A, B, or A and B. In addition, the technical solutions of the various embodiments can be combined with each other, but must be based on the realization by those skilled in the art. When the combination of technical solutions is contradictory or cannot be realized, it should be considered that the combination of such technical solutions does not exist and is not within the scope claimed by the present application.

The present application provides a virtual reality glove 100.

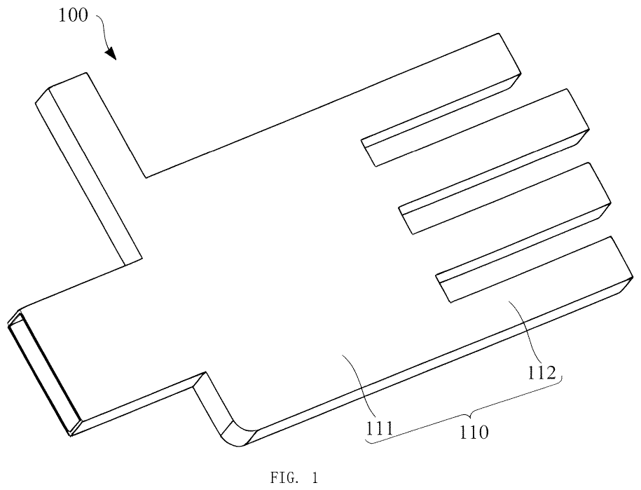

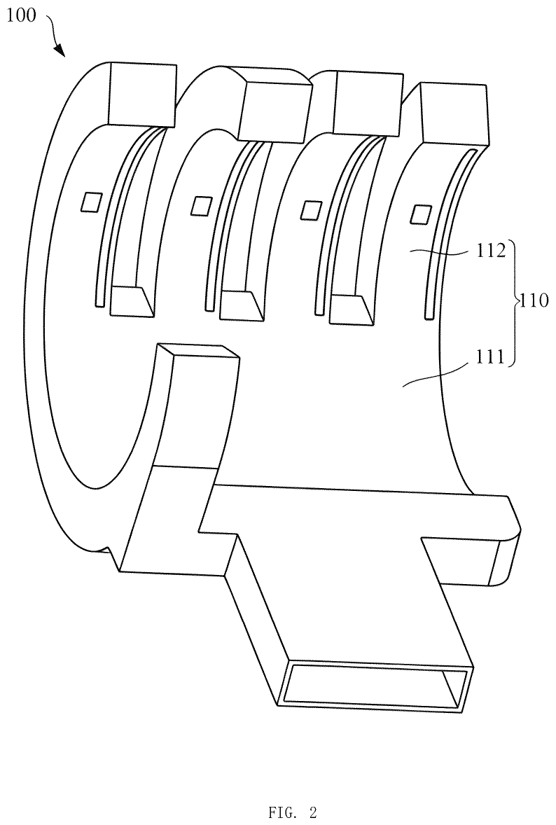

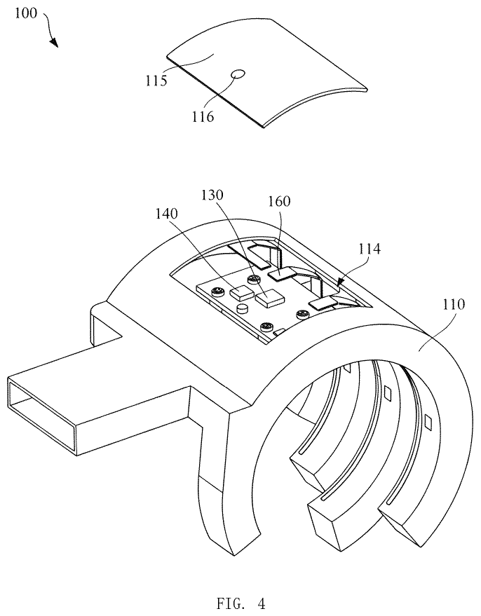

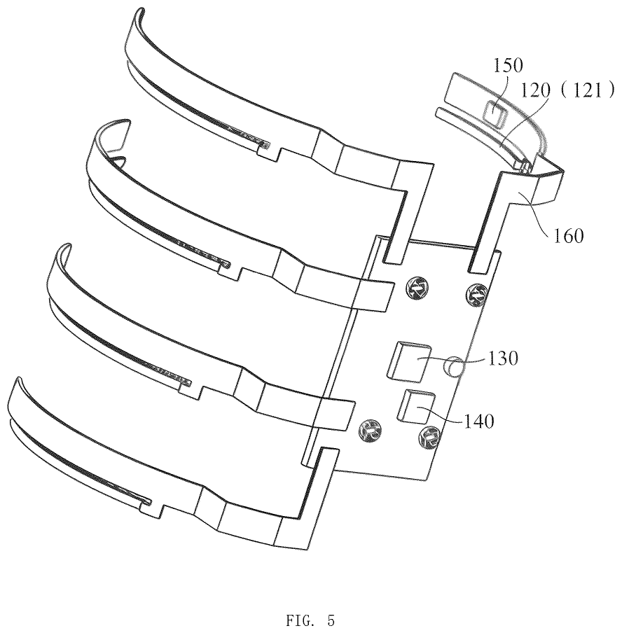

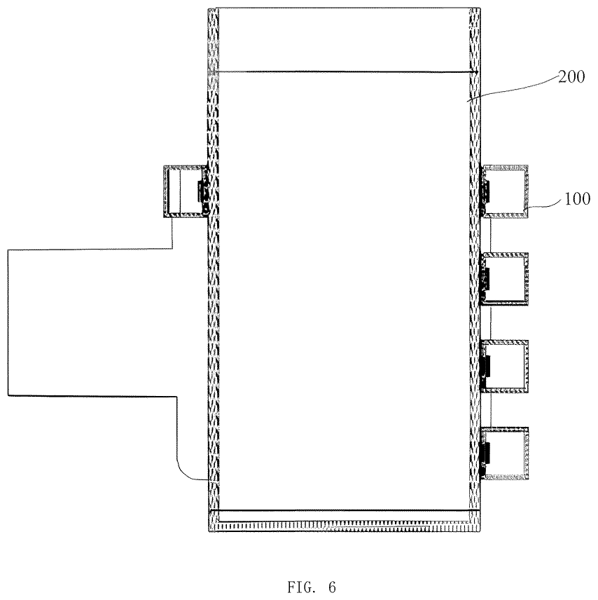

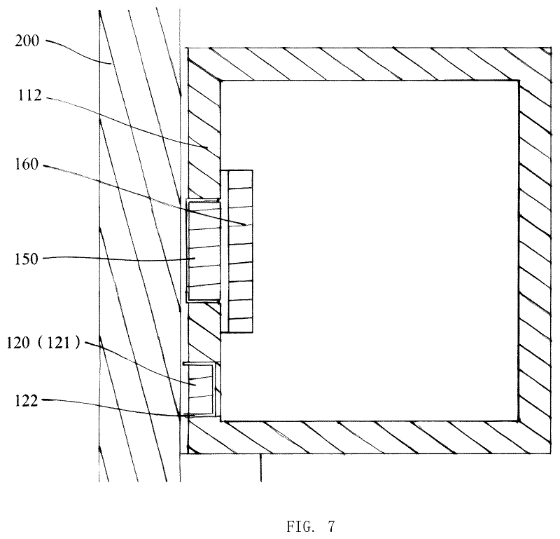

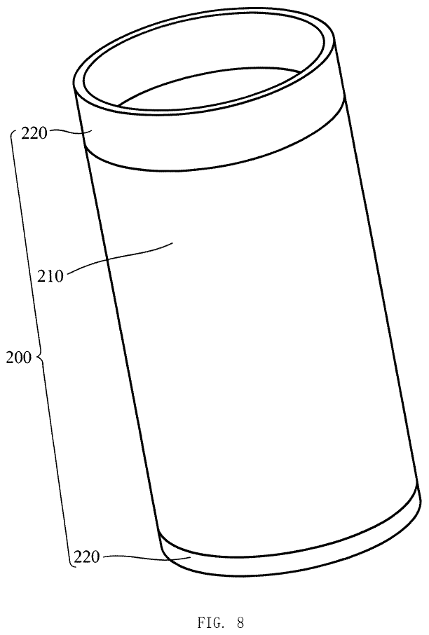

In the embodiments of the present application, as shown in FIGS. 1 to 8, the virtual reality glove 100 includes: a glove body 110, a heater 120, a controller 130, a communicator 140 and a mode switch. The heater 120 is provided at the glove body 110 and configured to heat a container to be heated held by the glove body 110. The controller 130 is provided at the glove body 110 and electrically connected to the heater 120. The communicator 140 is provided at the glove body 110 and electrically connected to the controller 130. The mode switch is provided at the glove body 110 and electrically connected to the controller 130.

The virtual reality glove 100 switches between a real-world application mode and a virtual application mode through the mode switch. In the real-world application mode, the controller 130 is configured for controlling the heater 120 to operate. In the virtual application mode, the controller 130 is in communication with a virtual reality device through the communicator 140 to send a trigger instruction for capturing a motion of the glove body 110 to the virtual reality device.

Specifically, both the heater 120 and the controller 130 are provided at the glove body 110. The heater 120 can heat the container to be heated held by the glove body 110 and is electrically connected to the controller 130. The container to be heated contains a liquid to be heated. In the real-world application mode, a user can wear the virtual reality glove 100 and hold the container to be heated, and then the controller 130 controls the heater 120 to operate, so that the heater 120 heats the container to be heated to warm the liquid to be heated to a preset temperature, thereby realizing the function of the virtual reality glove 100 to heat the container to be heated in real life.

The virtual reality device can construct a virtual space identical to the real scene, and the virtual reality device can be an AR glasses, VR glasses or other products. The mode switch can enable the virtual reality glove 100 to switch between the real-world application mode and the virtual application mode, that is, the mode switch can control the communication connection between the virtual reality glove 100 and the virtual reality device. For example, after the user wears the virtual reality device, turning on the mode switch allows access to the metaverse. The controller 130 then is in communication with the virtual reality device through the communicator 140 to connect the virtual reality glove 100 to the metaverse and send a trigger instruction for capturing the motion of the glove body 110 to the virtual reality device. This allows the virtual reality device to capture the motion of the glove body 110 and map it to the metaverse. That is, when the user wears the virtual reality glove 100 and performs a motion such as moving, gripping or opening the virtual reality glove 100, the virtual glove in the metaverse also performs the same motion. In this way, the user can control the virtual reality glove 100 in real life to control the virtual glove to perform a corresponding function in the metaverse. For example, by controlling the movement of the virtual reality glove 100, the virtual glove moves close to the virtual container to be heated in the metaverse; then, by controlling the gripping motion of the virtual reality glove 100, the virtual glove grips the virtual container to be heated in the metaverse, so that the virtual glove heats the virtual container to be heated and warms the virtual liquid to be heated in the virtual container to be heated to a preset temperature. This realizes the heating function of the virtual glove in the metaverse, which corresponds to the function of the virtual reality glove 100 in real life, making the virtual reality glove 100 integrate real-world and metaverse applications. Thus, the present application provides an intelligent device that allows a user to perform a preset action in real life and a corresponding virtual action in the metaverse by wearing the same device with the assistance of the virtual reality device. This further enhances the interactivity between the metaverse and the real world, enabling the user to experience a stronger sense of realism in the metaverse that is indistinguishable from the real world.

The mode switch is provided at the glove body 110. In other embodiments, the mode switch may also be provided at the virtual reality device. In one embodiment, when the mode switch is switched to the virtual application mode, the virtual reality device pops up a selection window in the virtual space for the user to select whether the controller 130 is in communication with the virtual reality device. Specifically, the mode switch may only control the virtual reality glove 100 to switch to the virtual application mode but not control whether the virtual reality glove 100 accesses the metaverse. For example, after the mode switch is turned on, a selection window pops up in the metaverse for the user to select whether the virtual reality glove 100 accesses the metaverse. In another embodiment, the mode switch may control both the virtual reality glove 100 to switch to the virtual application mode and whether the virtual reality glove 100 accesses the metaverse, that is, the virtual reality glove 100 accesses the metaverse immediately after the mode switch is turned on.

In the real world, whether the liquid to be heated reaches the preset temperature can be detected by a thermometer or human hand perception. In the metaverse, to enable the user to intuitively feel the temperature of the virtual liquid to be heated, in one embodiment, the virtual reality glove 100 is further provided with a temperature feedback apparatus communicatively connected to the controller 130 and the virtual reality product respectively. In the virtual application mode, the controller 130 is in communication with the temperature feedback apparatus to control the temperature feedback apparatus to operate. Specifically, the temperature feedback apparatus may be provided at the virtual reality glove 100 (e.g., fingertips). In the virtual application mode, the controller 130 is in communication with the temperature feedback apparatus to convert the temperature information of the virtual liquid to be heated into an electrical signal and transmit it to the temperature feedback apparatus. When the user contacts the virtual container to be heated through the temperature feedback apparatus, the temperature feedback apparatus generates a corresponding temperature and transmits it to the human hand, further enabling the user to experience a stronger sense of realism in the metaverse that is indistinguishable from the real world. In other embodiments, a pop-up window displaying the temperature change may appear when the virtual glove grips the virtual container to be heated, so that the user can intuitively detect the temperature change of the virtual liquid to be heated. A virtual temperature detection apparatus may also be provided to allow the user to intuitively detect the temperature change of the virtual liquid to be heated.

The communicator 140 may be configured as a wired communicator or a wireless communicator. When the communicator 140 is configured as the wireless communicator, the wireless communicator includes a Bluetooth module, a WIFI module, a radio frequency module, and a data transmission module.

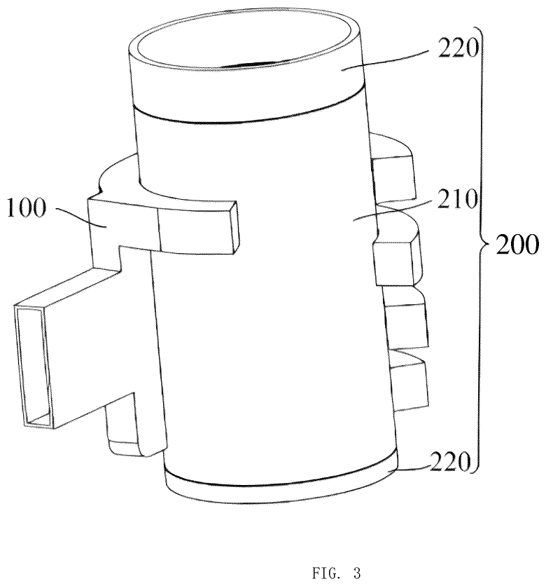

With reference to FIGS. 3, 6 to 8, in one embodiment, the container to be heated is configured as a cup to be heated 200. The cup to be heated 200 includes a heat conduction section 210 and two thermal insulation sections 220 provided at two ends of the heat conduction section 210. The heater 120 heats the heat conduction section 210 to heat the liquid to be heated in the cup to be heated 200. Specifically, the liquid to be heated is contained in the cup to be heated 200. The glove body 110 grips the cup to be heated 200 and heats the liquid to be heated in the cup to be heated 200 by heating the heat conduction section 210. The heat conduction section 210 can conduct heat, so the glove body 110 mainly grips the heat conduction section 210, allowing the heater 120 to heat the liquid to be heated by heating the heat conduction section 210. To reduce the risk of the heated cup scalding the table or the user's mouth, both ends of the heat conduction section 210 are provided with thermal insulation sections 220, that is, the bottom and mouth of the cup to be heated 200 are thermally insulated. Correspondingly, the virtual container to be heated in the metaverse may also be a virtual cup to be heated 200, which includes a heat conduction section 210 and two thermal insulation sections 220 provided at two ends of the heat conduction section 210.

The technical solution of the present application provides a glove body 110, and the glove body 110 is provided with a heater 120, a controller 130, a communicator 140 and a mode switch. The heater 120 is configured to heat a container to be heated held by the glove body 110. All of the controller 130, the communicator 140 and the mode switch are electrically connected to the heater 120. In the real-world application mode, a user can wear the virtual reality glove 100 and hold the container to be heated, and then the controller 130 controls the heater 120 to operate, so that the heater 120 heats the container to be heated to warm the liquid to be heated to a preset temperature, thereby realizing the function of the virtual reality glove 100 to heat the container to be heated in real life. The mode switch enables the virtual reality glove 100 to switch between the real-world application mode and the virtual application mode. After the user wears the virtual reality device, turning on the mode switch allows access to the metaverse. The controller 130 then is in communication with the virtual reality device through the communicator 140 to connect the virtual reality glove 100 to the metaverse and send a trigger instruction for capturing the motion of the glove body 110 to the virtual reality device. This allows the virtual reality device to capture the motion of the glove body 110 and map it to the metaverse, thereby realizing the heating function of the virtual glove in the metaverse, which corresponds to the function of the virtual reality glove 100 in real life. The virtual reality glove 100 thus integrates real-world and metaverse applications, providing an intelligent device that allows a user to perform a preset action in real life and a corresponding virtual action in the metaverse by wearing the same device with the assistance of the virtual reality device. This further enhances the interactivity between the metaverse and the real world, enabling the user to experience a stronger sense of realism in the metaverse that is indistinguishable from the real world.

With reference to FIGS. 1 to 8, in one embodiment, the glove body 110 includes a main body portion 111 and a plurality of finger portions 112 provided at the main body portion 111. The controller 130 and the communicator 140 are provided at the main body portion 111. The heater 120 includes a plurality of heating members 121 provided on at least one of the main body portion 111 and the finger portions 112. When the heater 120 is provided at the finger portions 112, the plurality of heating members 121 are correspondingly provided at sides of the plurality of finger portions 112 facing the container to be heated. Specifically, the main body portion 111 is the palm portion of the glove. The controller 130 and the communicator 140 are provided at the main body portion 111. Correspondingly, the heater 120 may be provided only on the finger portions 112, only on the main body portion 111, or on both the main body portion 111 and the finger portions 112. When the heater 120 is provided only on the finger portions 112, the heating members 121 are located on sides of the finger portions 112 facing the container to be heated, helping the heating members 121 directly heat the container to be heated and improving the layout rationality of the controller 130, the communicator 140 and the heater 120 on the glove body 110.

Further, the heating members 121 extend along an extension direction of the finger portions 112, and a thermal insulation member 113 is provided at a side of each heating member 121 facing away from the container to be heated. Specifically, the heating members 121 extend along the extension direction of the finger portions 112, so that when the glove body 110 grips the cup to be heated 200, the heating members 121 surround the container to be heated, improving the heating uniformity and efficiency of the heater 120. The heating members 121 are generally configured as heating wires, and the thermal insulation member 113 is provided at a side of each heating member 121 facing away from the container to be heated to reduce the risk of the heating wires scalding the human hand.

A mounting cavity 114 for mounting the controller 130 is formed in the glove body 110. The mounting cavity 114 is provided with an opening facing outward, and a mounting cover plate 115 covers the opening. A control switch 116 is fixed on the mounting cover plate 115 and electrically connected to the controller 130. Specifically, the controller 130 includes a control circuit board and a control chip provided at the control circuit board. The communicator 140 may also be correspondingly provided at the control circuit board and electrically connected to the control chip through the control circuit board. The mounting cavity 114 is provided at an outer side of the glove body 110 and has an opening facing outward. The mounting cover plate 115 covers the opening to reduce the influence of the controller 130 and the Bluetooth module on the posture change of the glove body 110. To facilitate the operation of the controller 130, the mounting cover plate 115 is provided with a control switch 116 electrically connected to the controller 130, allowing the user to directly control the operation of the controller 130 through the control switch 116 without opening the mounting cover plate 115, thereby facilitating user operation.

Furthermore, the glove body 110 is further provided with a container detector electrically connected to the controller 130. The container detector is configured to sense that the glove body 110 contacts or approaches the container to be heated and transmit a signal to the controller 130 to drive the heater 120 to operate. Specifically, the container detector can sense that the glove body 110 grips the container to be heated, transmit a signal to the controller 130, and the controller 130 controls the heater 120 to operate according to the feedback of the container detector. When the glove body 110 leaves the container to be heated, the container detector also generates a corresponding signal and transmits it to the controller 130, and the controller 130 controls the heater 120 to stop operating.

In one embodiment, the container detector is configured as a pressure sensor 150. The pressure sensor 150 is configured to sense a pressing force applied by the glove body 110 to the container to be heated and transmit a signal to the controller 130 to drive the heater 120 to operate. Specifically, when the pressing force applied by the glove body 110 to the container to be heated reaches a preset pressure or a preset pressure range, the pressure sensor 150 is triggered to transmit a signal to the controller 130, and the controller 130 controls the heater 120 to operate according to the feedback of the pressure sensor 150. This allows the user to control the heating of the container to be heated by the heater 120 according to the gripping force. Correspondingly, to determine whether the virtual liquid to be heated reaches the preset temperature, a pop-up window displaying the pressure change may appear when the virtual glove grips the virtual container to be heated, allowing the user to observe the temperature change of the virtual liquid to be heated. This gives the user a feeling that the heating of the virtual container to be heated by the virtual glove can be controlled according to the gripping force, improving the user's sense of realism. In other embodiments, a pop-up window displaying the temperature change or heating duration may appear when the virtual glove grips the virtual container to be heated, allowing the user to observe the temperature change of the virtual liquid to be heated. In yet another embodiment, a target temperature, target pressure or target duration may be preset before the virtual glove grips the virtual container to be heated, and a corresponding pop-up warning window appears when the virtual glove grips the virtual container to be heated to reach the target temperature, target pressure or target duration.

In real life, in one embodiment, a plurality of pressure sensors 150 are provided. The controller 130 acquires a plurality of pressure values from the plurality of pressure sensors 150, calculates an average pressure value based on the plurality of pressure values, and drives the heater 120 to operate according to the average pressure value. Specifically, since the plurality of pressure sensors 150 are usually provided at different positions on the virtual reality glove 100, the pressure values sensed by the plurality of pressure modules 150 are usually different. When the controller 130 acquires the plurality of pressure values, it can calculate an average pressure value based on the plurality of pressure values, and drive the heater 120 to operate when the average pressure value reaches a preset pressure or a preset pressure range. In other embodiments, the controller 130 may also separately acquire the pressure values on different pressure sensors 150, determine whether the different pressure values reach a preset pressure or a preset pressure range, and control different heating members 121 to operate accordingly.

Further, a first pressure range and a second pressure range are preset in the controller 130, and the first pressure range is lower than the second pressure range.

When the average pressure value falls within the first pressure range, the controller 130 does not drive the heater 120 to operate; and when the average pressure value falls within the second pressure range, the controller 130 drives the heater 120 to operate.

Specifically, the controller 130 determines the pressure range of the calculated average pressure value. When the average pressure value falls within the first pressure range, the controller 130 does not drive the heater 120 to operate; and when the average pressure value falls within the second pressure range, the controller 130 drives the heater 120 to operate, thereby controlling the operation of the heater 120. It can be understood that the first pressure range is lower than the second pressure range. For example, the first pressure range is set to 0-1 Pa, representing the user normally gripping the container to be heated; and the second pressure range is set to greater than 1 Pa, representing the user tightly gripping the container to be heated to warm the liquid to be heated in the container to be heated. The second pressure range may also be divided into a plurality of sub-ranges with different pressure ranges, and the larger the pressure range of the sub-range, the higher the power of the corresponding heater 120, allowing the user to control the heating efficiency of the virtual reality glove 100 according to the gripping force.

In another embodiment, the container detector includes a position sensor and an attitude sensor. When the position sensor senses that the glove body 110 contacts the container to be heated and the attitude sensor senses that the finger portions 112 of the glove body 110 are bent, a signal is transmitted to the controller 130 to drive the heater 120 to operate.

To improve the sensitivity of the container detector, in one embodiment, the glove body 110 includes a main body portion 111 and a plurality of finger portions 112 provided at the main body portion 111. A plurality of container detectors are correspondingly provided at sides of the plurality of finger portions 112 facing the container to be heated. Specifically, the container detectors are provided at sides of the finger portions 112 facing the container to be heated, helping improve the accuracy of the container detectors. Each finger portion 112 is provided with a container detector corresponding to the heater 120, which helps further improve the accuracy of the container detectors and enables the heaters 120 to operate independently to precisely control the heating of the container to be heated by the virtual reality glove 100.

In one embodiment, the container detector is electrically connected to the controller 130 through a flexible printed circuit 160, and the flexible printed circuit 160 extends from the container detector to the controller 130. This not only reduces wiring chaos but also does not affect the normal bending of the finger portions 112.

In another embodiment, the heater 120 is electrically connected to the controller 130 through a flexible printed circuit 160, and the flexible printed circuit 160 extends from the heater 120 to the controller 130. This not only reduces wiring chaos but also does not affect the normal bending of the finger portions 112. In this embodiment, the heater 120 is first electrically connected to the container detector and then connected to the controller 130 through the same flexible printed circuit 160.

The present application further provides a virtual reality product, which includes a virtual reality device and the virtual reality glove 100. Reference may be made to the above embodiments for the specific structure of the virtual reality glove 100. Since the virtual reality product adopts all the technical solutions of the above embodiments, it has at least all the beneficial effects brought by the technical solutions of the above embodiments, which will not be repeated herein one by one. The controller 130 of the virtual reality glove 100 is communicatively connected with the virtual reality device through the communicator 140.

Specifically, the virtual reality device includes a 3D construction module and a real-world capture module that are communicatively connected. The 3D construction module constructs a virtual space, and the virtual space is provided with a virtual glove corresponding to the glove body 110 and a virtual container to be heated corresponding to the container to be heated.

In the virtual application mode, the controller 130 is communicatively connected to the 3D construction module and the real-world capture module through the communicator 140 respectively. The real-world capture module captures the motion of the glove body 110 and maps the motion to the virtual glove, so that the virtual glove holds the virtual container to be heated and heats the virtual container to be heated.

The 3D construction module can construct a virtual space identical to the real scene, thereby building a virtual glove corresponding to the glove body 110 and a virtual container to be heated corresponding to the container to be heated, realizing a one-to-one restoration of the virtual reality glove 100 and the container to be heated. The controller 130 is communicatively connected to the 3D construction module, allowing the real-world capture module to capture the motion of the glove body 110 and map it to the virtual glove. That is, when the user wears the virtual reality glove 100 and performs a motion, such as moving, gripping or opening the virtual reality glove 100, the virtual glove in the metaverse also performs the same motion. Thus, the user can control the movement of the virtual reality glove 100 in real life to make the virtual glove move close to the virtual container to be heated in the metaverse, and then control the gripping motion of the virtual reality glove 100 to make the virtual glove grip the virtual container to be heated in the metaverse, so that the virtual glove heats the virtual container to be heated and warms the virtual liquid to be heated in the virtual container to be heated to a preset temperature, thereby realizing the heating function of the virtual glove in the metaverse.

Further, the real-world capture module includes a camera module, a sensor module and a mapping module. The mapping module is communicatively connected to the 3D construction module. The camera module and the sensor module are configured to monitor the motion of the glove body 110 and transmit the motion to the mapping module, and the mapping module maps the motion to the virtual glove. Specifically, the camera module and the sensor module jointly monitor the motion of the glove body 110, and then map the motion to the virtual glove through the mapping module, so that the virtual glove in the metaverse can perform the same motion as the glove body 110 in real life.

In one embodiment, in the virtual application mode, the virtual glove heats the virtual container to be heated to a target temperature. The controller acquires the target temperature, and upon detecting that the temperature feedback apparatus on the virtual reality glove 100 contacts the virtual container to be heated, the controller 130 controls the temperature feedback apparatus to operate to feed back the target temperature to the user. Specifically, the controller 130 acquires the target temperature and is in communication with the temperature feedback apparatus. When detecting that the virtual temperature feedback apparatus corresponding to the virtual glove overlaps with the virtual container to be heated, the real-world capture module transmits a signal to the virtual reality device, and the virtual reality device further transmits the signal to the controller 130. The controller 130 converts the temperature information of the virtual liquid to be heated into an electrical signal and transmits it to the temperature feedback apparatus, so that the temperature feedback apparatus generates a corresponding temperature and transmits it to the human hand. This allows the user to intuitively feel the temperature of the virtual container to be heated, further enabling the user to experience a stronger sense of realism in the metaverse that is indistinguishable from the real world.

In another embodiment, in the virtual application mode, the virtual glove heats the virtual container to be heated to a target temperature. The 3D construction module constructs a virtual temperature detection apparatus, the virtual temperature detection apparatus detects a temperature of the virtual container to be heated, and the virtual reality device acquires the target temperature and displays the target temperature in the virtual space. Specifically, the user can call up the virtual temperature detection apparatus in the virtual space to detect the temperature of the virtual container to be heated. At this time, the controller 130 transmits the acquired target temperature to the virtual reality device, and the virtual reality device then pops up a pop-up window displaying the corresponding target temperature value, allowing the user to intuitively observe the temperature of the container to be heated.

The above are only preferred embodiments of the present application, and are not intended to limit the scope of the present application. Any equivalent structural transformation made by using the contents of the description and drawings of the present application under the inventive concept of the present application, or direct/indirect application in other related technical fields, is included in the scope of the present application.

What is claimed is:

1. A virtual reality glove, comprising:
a glove body;
a heater provided at the glove body and configured to heat a container to be heated held by the glove body;
a controller provided at the glove body and electrically connected to the heater;
a communicator provided at the glove body and electrically connected to the controller; and
a mode switch provided at the glove body and electrically connected to the controller;
wherein the virtual reality glove is configured to switch between a real-world application mode and a virtual application mode through the mode switch;
in the real-world application mode, the controller is capable of controlling the heater to operate; and
in the virtual application mode, the controller is in communication with a virtual reality device through the communicator to send a trigger instruction for capturing a motion of the glove body to the virtual reality device.

2. The virtual reality glove according to claim 1, wherein:
the glove body comprises a main body portion and a plurality of finger portions provided at the main body portion, and the controller and the communicator are provided at the main body portion; and
the heater comprises a plurality of heating members provided on at least one of the main body portion and the plurality of finger portions, and the plurality of heating members are correspondingly provided at sides of the plurality of finger portions facing the container to be heated when the heater is provided at the plurality of finger portions.

3. The virtual reality glove according to claim 2, wherein the plurality of heating members extend along extension directions of the plurality of finger portions, and a thermal insulation member is provided at one sides of the plurality of heating members facing away from the container to be heated.

4. The virtual reality glove according to claim 1, wherein a container detector is provided at the glove body and electrically connected to the controller, the container detector is configured to sense that the container to be heated is held by the glove body and transmit the information to the controller to drive the heater to operate.

5. The virtual reality glove according to claim 4, wherein the container detector is configured as a pressure sensor, the pressure sensor is configured to sense a pressing force applied by the glove body to the container to be heated and transmit the information to the controller to drive the heater to operate.

6. The virtual reality glove according to claim 5, wherein a plurality of pressure sensors are provided, the controller is configured to acquire a plurality of pressure values from the plurality of pressure sensors, calculate an average pressure value based on the plurality of pressure values, and drive the heater to operate according to the average pressure value.

7. The virtual reality glove according to claim 6, wherein:
a first pressure range and a second pressure range are preset in the controller, and the first pressure range is lower than the second pressure range;
in response to determining that the average pressure value falls within the first pressure range, the controller does not drive the heater to operate; and
in response to determining that the average pressure value falls within the second pressure range, the controller drives the heater to operate.

8. The virtual reality glove according to claim 4, wherein at least one of the heater and the container detector is electrically connected to the controller through a flexible printed circuit, and the flexible printed circuit is configured to extend from at least one of the heater and the container detector to the controller.

9. The virtual reality glove according to claim 1, wherein:
a mounting cavity for mounting the controller is formed in the glove body, and the mounting cavity is provided with an opening facing outward; and
a mounting cover plate is configured to cover the opening, a control switch is fixed on the mounting cover plate, and the control switch is electrically connected to the controller.

10. The virtual reality glove according to claim 1, further comprising a temperature feedback apparatus communicatively connected to the controller and the virtual reality device respectively, wherein in the virtual application mode, the controller is in communication with the temperature feedback apparatus to control the temperature feedback apparatus to operate.

11. A virtual reality product, comprising:
a virtual reality device; and
the virtual reality glove according to claim 1,
wherein a controller of the virtual reality glove is communicatively connected to the virtual reality device through a communicator.

12. The virtual reality product according to claim 11, wherein:
the virtual reality device comprises a 3D construction module and a real-world capture module communicatively connected to the 3D construction module, the 3D construction module is configured to construct a virtual space, and the virtual space comprises a virtual glove corresponding to a glove body and a virtual container to be heated corresponding to a container to be heated; and
in a virtual application mode, the controller is communicatively connected to the 3D construction module and the real-world capture module through the communicator respectively, the real-world capture module is configured to capture a motion of the glove body and map to the virtual glove, so that the virtual glove is configured to hold the virtual container to be heated and heat the virtual container to be heated.

13. The virtual reality product according to claim 12, wherein the real-world capture module comprises a camera module, a sensor module and a mapping module communicatively connected to the 3D construction module, the camera module and the sensor module are configured to monitor the motion of the glove body and transmit to the mapping module, and the mapping module is configured to map to the virtual glove.

14. The virtual reality product according to claim 12, wherein:
in the virtual application mode, the virtual glove is configured to heat the virtual container to be heated to a target temperature; and
the controller is configured to acquire the target temperature, and control a temperature feedback apparatus to operate to feed back the target temperature to a user when detecting that the temperature feedback apparatus on the virtual reality glove contacts the virtual container to be heated.

15. The virtual reality product according to claim 12, wherein:
in the virtual application mode, the virtual glove is configured to heat the virtual container to be heated to a target temperature; and
the 3D construction module is configured to construct a virtual temperature detection apparatus, the virtual temperature detection apparatus is configured to detect a temperature of the virtual container to be heated, and the virtual reality device is configured to acquire the target temperature and display the target temperature in the virtual space.

16. The virtual reality product according to claim 12, wherein a mode switch is switched to the virtual application mode, the virtual reality device is configured to pop up a selection window in the virtual space for a user to select whether the controller is in communication with the virtual reality device.

17. The virtual reality product according to claim 11, further comprising a container to be heated, wherein the container to be heated is configured as a cup to be heated, the cup to be heated comprises a heat conduction section and two thermal insulation sections provided at two ends of the heat conduction section, and the heater is configured to heat conduction section to heat a liquid to be heated in the cup to be heated.
